(19) United States
(12) Patent Application Publication
(10) Pub. No.: US 2025/0045122 A1
(43) Pub. Date: Feb. 6, 2025

(54) MACHINE LEARNING MODEL SCALABILITY WITH DISTRIBUTED MULTI-LAYER PROCESSING

(71) Applicant: Expedera, Inc., Santa Clara, CA (US)

(72) Inventors: Shang-Tse Chuang, Los Altos, CA (US); Siyad Chih-Hua Ma, Palo Alto, CA (US); Sharad Vasantrao Chole, San Jose, CA (US); Costas Calamvokis, Bath (GB)

(21) Appl. No.: 18/789,431

(22) Filed: Jul. 30, 2024

Related U.S. Application Data
(60) Provisional application No. 63/530,849, filed on Aug. 4, 2023.

(51) Int. Cl. G06F 9/50; G06F 9/54

(52) U.S. Cl. CPC G06F 9/5077; G06F 9/54

(57) ABSTRACT

Machine learning model scalability with distributed multi-layer processing is disclosed herein. A method for processing and deploying machine learning models that enhances scalability and efficiency by executing a subset of a neural network on each of a plurality of interconnected processing units. The method involves partitioning compute tasks across these processing units to reduce latency, including broadcast and reduction processes for inputs and outputs. It also includes managing the allocation of samples in a batch to specific master processing units within the distributed arrangement and synchronizing computation between fully connected layers within each processing unit. Additionally, the method implements data reduction during the transfer of data across the processing units, wherein data is accumulated with a current processing unit's partial sum as it is transferred to the destination processing unit.

### CROSS REFERENCE TO RELATED APPLICATIONS

This application claims the benefit and priority of U.S. Provisional Application Ser. No. 63/530,849, filed on Aug. 4, 2023, which is hereby incorporated by reference herein in its entirety, including all references and appendices cited therein, for all purposes.

### FIELD

The present disclosure relates generally to the field of computer processing systems, and more specifically to methods and systems for enhancing the scalability and efficiency of machine learning model processing and deployment.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for processing and deploying a machine learning model. The method also includes executing a subset of a neural network on each of a plurality of processing units interconnected through an interposer or in direct communication with one another, where each processing unit may include a high-bandwidth memory (HBM) stack and a compute layer integrated into a single stack; partitioning compute tasks for a machine learning model across the plurality of processing units to reduce latency and increase capacity, including broadcast and reduction processes for inputs and outputs; managing allocation of samples in a batch to specific master processing units within the plurality of processing units; and synchronizing computation of the machine learning model between fully connected layers within each processing unit, where the processing units are interconnected by an interposer that enables high-speed communication and distributed processing. Other embodiments of this aspect include corresponding computer systems, apparatus, and computer programs recorded on one or more computer storage devices, each configured to perform the actions of the methods.

Implementations may include one or more of the following features. The method may include enabling localized execution of machine learning model computations to reduce data transfer latency by integrating the HBM stack with the compute layer. The method may include compiling a scheduling process without synchronization, where the scheduling process accounts for worst-case latency variations and is determined during compile time and implemented during runtime. The method may include fine-tuning weights of a machine learning model performed on the plurality of processing units where the weights are stored. The method may include broadcasting data in a deeply pipelined fashion from a master processing unit to all other processing units in a same row and column within plurality of processing units. The method may include implementing data reduction during transfer of data across the plurality of processing units, where data is accumulated with a current processing unit's partial sum during transfer to a destination processing unit of the plurality of processing units. Multicycle commands are represented by packets, which include layer metadata, memory pointers, and scheduling information. Commands can be compiled before executing the methods disclosed herein a processing unit. The method may include using a key-value (KV) cache for storing and retrieving data, where availability of the KV cache reduces a required multiply-accumulate (MAC) operations in a first fully connected layer of each transformer block. The partitioning of compute tasks includes execution of multi-headed attention blocks, where each attention head is processed independently on different processing units within memory stacks. The method may include normalizing outputs within each processing unit after the computation of multi-headed attention and fully connected layers, ensuring that normalization occurs on a single processing unit within each memory stack. Implementations of the described techniques may include hardware, a method or process, or computer software on a computer-accessible medium.

One general aspect includes a system for processing and deploying machine learning models. The system also includes a plurality of high-bandwidth memory (HBM) stacks, each stack may include a plurality of dynamic random-access memory (DRAM) dies stacked vertically; a logic die associated with each HBM stack, where the logic die integrates a compute layer capable of executing a subset of a neural network; and an interposer layer on which the HBM stacks and logic dies are mounted, providing connectivity and routing between the logic dies and a package substrate. Other embodiments of this aspect include corresponding computer systems, apparatus, and computer programs recorded on one or more computer storage devices, each configured to perform the actions of the methods.

Implementations may include one or more of the following features. The system where the logic die is configured to: assign each sample in a batch to a specific master HBM stack within the distributed arrangement; independently perform computation between two fully connected layers, where a first layer performs a broadcast of inputs and a second layer performs a reduction of outputs; implement a scheduling process without runtime synchronization, where the scheduling process is determined during compile time and takes into account worst-case latency variations; and fine-tune weights for machine learning models directly on the logic die. The interposer layer is configured to: connect multiple HBM stacks and logic dies, forming a mesh grid to enable high-speed communication and distributed processing; and support scalable and efficient processing by providing additional connectivity and routing between the logic dies and a package substrate. The logical die is configured to: carry out deeply pipelined broadcasts of data from a master logic die to other logic dies in the same row and column; and implement data reduction during the transfer of data across the logic dies, wherein as data moves through the grid, it is accumulated with a current logic die's partial sum during transfer to a destination logic die. The logical die is configured to represent multicycle commands, may include layer metadata, memory pointers, and scheduling information, compiled on various computing elements within the plurality of computing elements. The logical die is configured to store and retrieve data from a key value (KV) cache, where availability of the KV cache reduces a computational load in a first fully connected (FC) layer by minimizing a number of multiply-accumulate (MAC) operations required, thereby reducing required memory and operations. In some instances, the allocation and deallocation of memory within the HBM stack occurs at compile time, ensuring efficient use of memory resources during machine learning model processing. Implementations of the described techniques may include hardware, a method or process, or computer software on a computer-accessible medium.

One general aspect includes a method for enhancing scalability and efficiency of machine learning model processing. The method also includes distributing subsets of a neural network across processing units that are interconnected; executing machine learning model computations on each of the processing units to leverage local memory and processing resources; dynamically partitioning and managing compute tasks to optimize latency, including broadcasting inputs and reducing outputs across the processing units; assigning batches of samples to master processing units to centralize certain computational tasks while distributing others; coordinating and synchronizing computation between fully connected layers within each processing unit to ensure efficient data processing; implementing a deeply pipelined broadcast of data from the master processing units to other processing units in the same row and column; performing data reduction during data transfers across the processing units, where data is aggregated with a current processing unit's partial sum during transfer to a destination; utilizing a key-value (KV) cache module for efficient data storage and retrieval, reducing a computational load and memory requirements in fully connected layers; and compiling multicycle commands into packets, which include layer metadata, memory pointers, and scheduling information, to facilitate execution across various processing units. Other embodiments of this aspect include corresponding computer systems, apparatus, and computer programs recorded on one or more computer storage devices, each configured to perform the actions of the methods.

Implementations may include one or more of the following features. The method where each processing unit may include a high-bandwidth memory (HBM) stack integrated with a compute layer, enabling localized execution of machine learning model computations to reduce data transfer latency. The method may include fine-tuning weights of the machine learning model on the processing units where the weights are stored, enhancing the efficiency of model updates without requiring external data transfer. Implementations of the described techniques may include hardware, a method or process, or computer software on a computer-accessible medium.

### BRIEF DESCRIPTION OF THE DRAWINGS

FIG. 1A illustrates an example standard chip architecture.

FIG. 1B illustrates a structure of a chip architecture of the present disclosure.

FIG. 2 illustrates the architecture of a machine learning model's multi-headed attention mechanism, demonstrating its partitioning across two chips and to enhance processing efficiency.

FIG. 3 illustrates the process of handling a single new token within one head of a multi-headed attention mechanism.

FIG. 4 illustrates how the multi-headed attention mechanism can be effectively distributed across multiple processing units, highlighting the steps of scaled dot-product attention, concatenation, linear transformation, and summation.

FIG. 5 illustrates how the final MLP stage can be effectively distributed across multiple processing units.

FIG. 6 provides an overview of the partitioning and execution on example processing units, such as chips or chiplets.

FIG. 7 illustrates the allocation of samples to chiplets within a batch processing system.

FIG. 8 illustrates the broadcast and reduction process within a chiplet array, referencing the example configuration of 4×4 chiplets shown.

FIG. 9 illustrates a method for processing and deploying a machine learning model, detailing the steps of executing subsets of a neural network on interconnected processing units, partitioning compute tasks to reduce latency, managing sample allocation to master processing units, and synchronizing computations between fully connected layers within each processing unit.

FIG. 10 depicts the method steps for localized execution and scheduling, including enabling localized execution of machine learning model computations, compiling a scheduling process without synchronization, and fine-tuning weights on the processing units where the weights are stored.

FIG. 11 illustrates the method steps for data handling and task partitioning, including broadcasting data in a deeply pipelined fashion, implementing data reduction during transfers, representing multicycle commands with packets, using a key-value cache, partitioning compute tasks for multi-headed attention blocks, and normalizing outputs within each processing unit.

### DETAILED DESCRIPTION OF EXAMPLE EMBODIMENTS

### Overview

Current hardware and software used in large Machine Learning model implementations suffer from various drawbacks, namely that they are not effectively scalable and current architectures are prone to latency. Examples of such models are LLMs (Large Language Models) and Vision-Transformers. In general, LLMs require a large amount of compute and memory resources; however, current hardware is not scalable, and methods for processing data are inefficient. Additionally, the transformer architecture, such as a neural network used with an LLM, which helps the LLM understand connections between data, may not be easily scalable. Transformers and the weights they use are largely a function of parameters such as the number of layers in the network and the embedding size (token embedding). Transformers and their weights may have billions of parameters, and LLM model sizes will only grow in complexity. Transformer activations are influenced by aspects such as batch size, embedding size, context window, attention algorithm, and key-value (KV) cache. Data processed by a transformer are handled with token batching; however, batch sizing is problematic and can increase the latency of the system. Regardless of whether small or large batching is used, each has associated drawbacks.

An example chip architecture includes a package substrate, an interposer layer, and a CPU/GPU controller surrounded by a plurality of chiplets arranged in a mesh grid on the interposer. Each chiplet comprises a compute base layer and vertically stacked High Bandwidth Memory (HBM) DRAM elements on a logical die. The CPU/GPU functionalities within each chiplet handle essential processing tasks, leveraging the high-speed memory provided by the HBM layers to enhance performance and reduce latency.

Attempts to increase parallelism by partitioning transformer blocks across GPUs often fail because tokens in LLMs must be computed in series, not in parallel. This necessity increases latency, as processing multiple tokens simultaneously without batching remains inefficient. Consequently, as transformer blocks in neural networks increase, so does the latency.

Neural networks are a class of machine learning models designed to recognize patterns and make decisions based on input data, inspired by the way biological neural networks in the human brain operate. They consist of layers of interconnected nodes, or neurons, where each layer transforms the input data in various ways, allowing the network to learn complex representations. In a typical neural network, there are input layers, hidden layers, and output layers, each playing a role in processing the data.

To optimize performance and efficiency, especially in large-scale applications, it is advantageous to separate or use subsets of the neural network. This approach involves dividing the neural network into smaller, manageable segments, such as subsets of full or partial layers. Each subset can be processed independently or in parallel across multiple processing units. By partitioning the compute tasks, the overall latency can be significantly reduced, and computational resources can be more effectively utilized. This method allows for distributed processing, where different subsets of the neural network can be executed simultaneously on various processing units. The results from these subsets are then synchronized and aggregated, ensuring that the overall computation of the neural network is coherent and efficient. This approach not only enhances processing speed but also enables scalable deployment of neural networks across a diverse range of hardware architectures.

Current hardware architectures, which separate compute and memory units, face significant scalability and latency issues. To address these challenges, the chip architectures disclosed herein integrate compute processing units directly into each stack of memory chiplets. This configuration eliminates the need to access the substrate layer of the architecture, thereby maximizing bandwidth between compute resources and memory. By embedding the compute units within the memory stacks, this architecture allows for the efficient distribution and parallel processing of subsets of neural networks, including full or partial layers, across multiple processing units. This method ensures that transformer layers and other neural network components are processed in a highly efficient manner, reducing power consumption and reliance on batching while significantly lowering latency. Consequently, this configuration provides a highly scalable solution, accelerating the inference generation of large language models (LLMs) and other complex machine learning models.

### Example Embodiments

The present disclosure pertains to machine learning model scalability with distributed multi-layer processing. The disclosed chip architectures integrate compute and memory resources within a unified design to enhance the scalability and efficiency of machine learning model processing. By embedding compute elements directly into memory stacks, these architectures maximize bandwidth and minimize latency between compute and memory components. This approach addresses traditional challenges like power inefficiency and batching dependencies by distributing computational tasks across multiple processing units, resulting in a highly scalable, low-latency solution that significantly accelerates the processing and deployment of large-scale machine learning models.

Embodiments address the breakdown of compute tasks within machine learning models, and focus on the synchronization and implementation of fully connected layers. Fully connected layers involve data synchronization on either the input or output side. If the computations between two fully connected layers are independent, they can be implemented efficiently. The first layer broadcasts inputs, ensuring data is disseminated across the necessary processing units, while the second layer consolidates the outputs, reducing the results from computations.

This disclosure also presents a method for fine-tuning using techniques like Low-Rank Adaptation (LORA). Fine-tuning updates the model's weights directly on the processing units where they are stored. This localized approach optimizes the fine-tuning process, enhancing the model's performance and adaptability while maintaining efficient use of hardware resources.

In detail, a processing unit is installed within each stack of memory processing units, instead of using separate units for compute and memory. The transformer block is distributed across multiple processing units, ensuring efficient communication within LLM layers. This architecture reduces power consumption and reliance on batching, providing a more scalable solution with reduced latency, thus accelerating LLM inference generation.

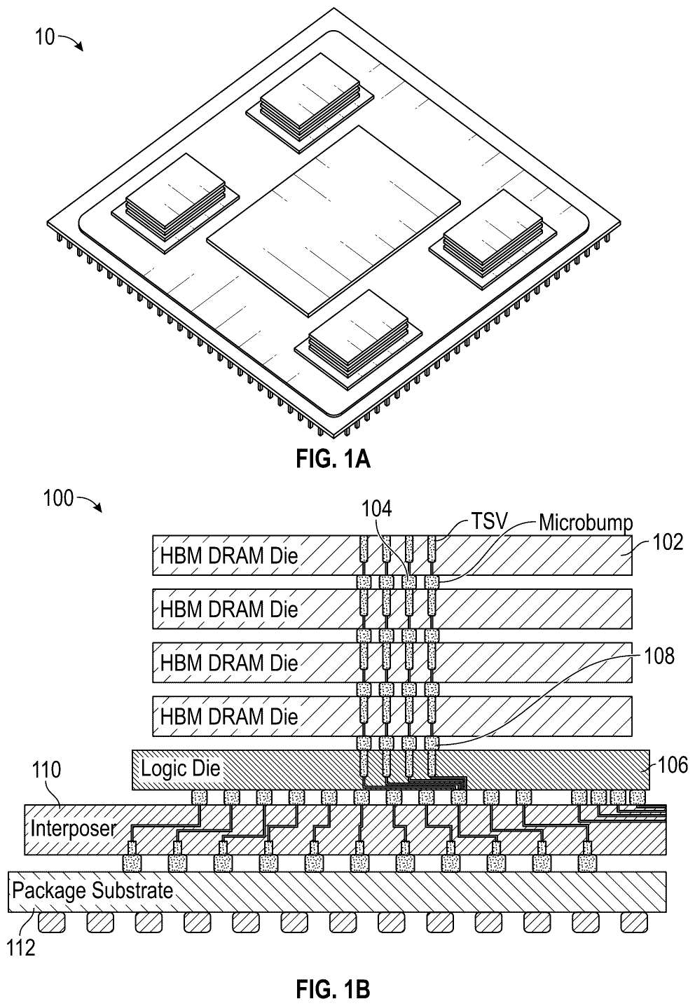

FIG. 1A illustrates an example standard chip architecture 10 having a central die. FIG. 1B illustrates a chip architecture 100 that eliminates the need for a central die by integrating compute elements directly into a logic die at the bottom of an HBM stack. This architecture features multiple vertically stacked High Bandwidth Memory (HBM) DRAM dies (HBM stack 102 comprised of stacked HBM DRAM Dies), interconnected using Through-Silicon Vias (TSVs) 104. The integrated CPU/GPU handles essential processing tasks, ensuring high-speed communication and reduced latency.

At the base of the HBM stack is a logic die 106, which houses the processing units. A logic die 106 is responsible for executing computations and is integrated directly with the HBM stack to minimize latency and maximize bandwidth. Microbumps 108 connect the HBM stack to the logic die, facilitating efficient communication between memory and compute layers, as well as the interposer and the package substrate.

The entire stack, comprising the HBM stack 102 and logical die 106, can be mounted on an interposer 110. The interposer provides additional connectivity and routing between the logic die and the package substrate 112. It allows multiple HBM stacks to be connected, enabling scalable and efficient processing. The package substrate serves as the foundation, housing the interconnections and providing mechanical support for the entire assembly. One example embodiment uses interposers or PCBs to connect multiple stacks, creating a mesh grid that facilitates high-speed communication and distributed processing across the stacks.

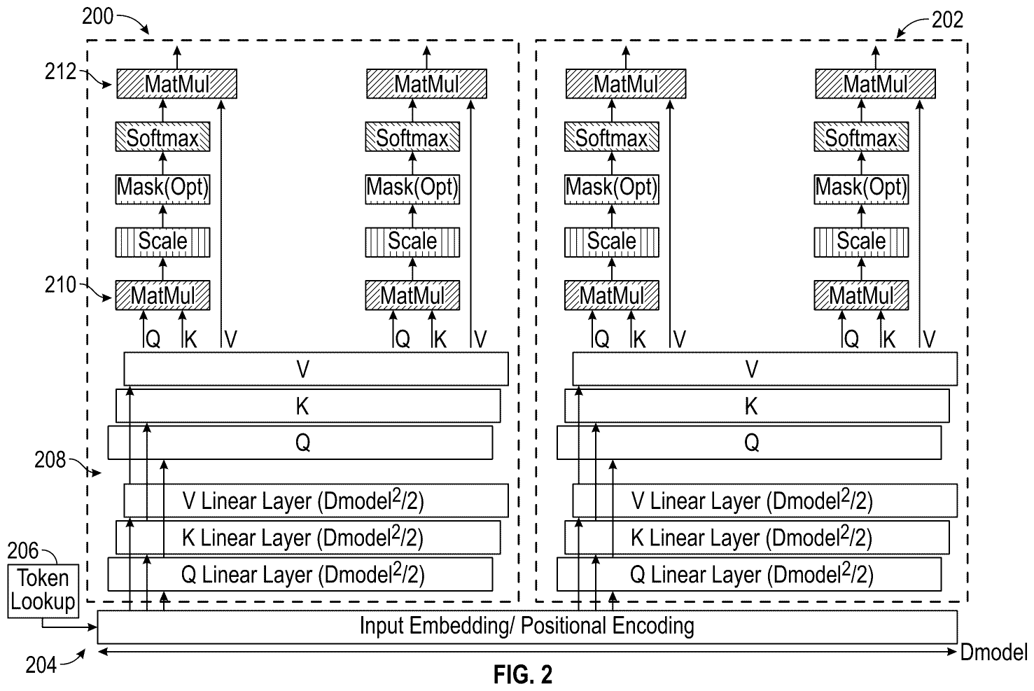

FIG. 2 illustrates the architecture of a machine learning model's multi-headed attention mechanism, partitioned across two chips, 200 and 202, to enhance processing efficiency. The process begins with Input Embedding and Positional Encoding 204, which converts tokenized input data into dense vector representations. Positional information is added to retain the order of tokens for subsequent transformations within the model.

In the Token Lookup 206 process, input tokens are mapped to their corresponding embeddings, retrieved from an embedding matrix. These embeddings serve as the basis for generating the Query (Q), Key (K), and Value (V) matrices. The Q, K, and V Linear Layers 208 transform the embeddings into these matrices, a task that can be split across two chips. Each chip handles half of the computations, effectively distributing the workload. The Q, K, and V linear layers each perform half of their respective matrix computations, denoted as:

D²model/2.

Following the linear transformations, the Q matrix undergoes a series of operations in the MatMul 210 stages. First, the Q matrix is multiplied by the K matrix. The resulting product is then scaled and optionally masked to handle padded tokens or apply specific attention mechanisms. This product is subsequently passed through a Softmax function, which normalizes the attention scores, converting them into a probability distribution. These attention scores are used to weight the V matrix through another MatMul operation 212. This step extracts relevant information from the V matrix based on the attention scores, producing the final output of the attention mechanism. Each of these operations is also split across the two chips, ensuring balanced and efficient management of the computational effort.

The architecture shown in FIG. 2 exemplifies the use of parallel processing and task distribution across multiple chips to handle the intensive computations required by the multi-headed attention mechanism. By splitting the workload across two chips 200 and 202, this approach minimizes latency and maximizes throughput, enabling the efficient processing of large-scale machine learning models. This setup illustrates a method of leveraging hardware resources to optimize the performance of complex neural network operations.

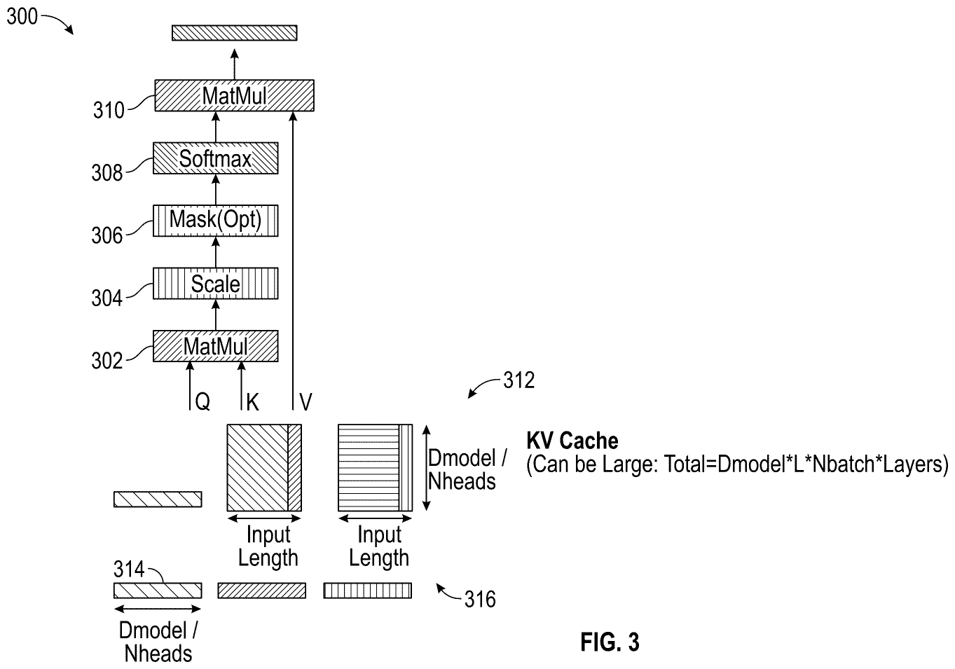

FIG. 3 illustrates the process 300 of handling a single new token within one head of a multi-headed attention mechanism. Overall, FIG. 3 demonstrates example steps involved in processing a single token within the attention mechanism, emphasizing the matrix operations and the use of a KV cache for optimized performance.

Processing begins with the generation of the Query, Key, and Value matrices 300 from the input embeddings. These matrices are essential components of the attention mechanism and are derived from the initial input tokens. The Query (Q) matrix undergoes a matrix multiplication (MatMul) operation 302 with the Key (K) matrix to produce a score matrix. This score matrix indicates the relevance of each key to the query, essentially highlighting the importance of each token in the context of the query token.

The resulting scores are then scaled 304 to stabilize the gradients and improve the training dynamics. An optional masking step 306 may follow, which is used to prevent attending to certain tokens, such as padding tokens or future tokens in the case of autoregressive models. Next, the scaled scores pass through a Softmax function 308 to convert them into a probability distribution. This distribution determines the weights for the Value (V) matrix during the subsequent attention calculation. The weighted Value matrix is then computed through another matrix multiplication (MatMul) operation 310. This step combines the information from the Value matrix according to the attention weights, producing the final output of the attention mechanism for the current token.

FIG. 3 also highlights the role of the key-value (KV) cache 312, which stores the Key and Value matrices. The KV cache can be substantial in size, as it depends on the model dimension (Dmodel), input length (L), batch size (Nbatch), and the number of layers. This cache facilitates efficient retrieval and reuse of previously computed keys and values, reducing redundant calculations.

Block 314 includes the vertical Dmodel/Nheads dimension of the Query, Key, and Value matrices after they have been split among the multiple heads in the multi-headed attention mechanism. Each head processes a portion of the overall model dimension (Dmodel), dividing it by the number of heads (Nheads). The Input length dimension represents the length of the input sequence. This dimension indicates the number of tokens in the input sequence that the model is processing.

Blocks 316 illustrate the split of the model dimensions and input lengths for the Q, K, and V matrices, showing how the data is distributed across different heads and input tokens. FIG. 3 illustrates how the data is partitioned and processed within the attention mechanism, ensuring efficient handling of the input sequence and reducing computational complexity. The combination of these elements illustrates the intricate process of computing attention scores and applying them to derive the final output for each token in the sequence.

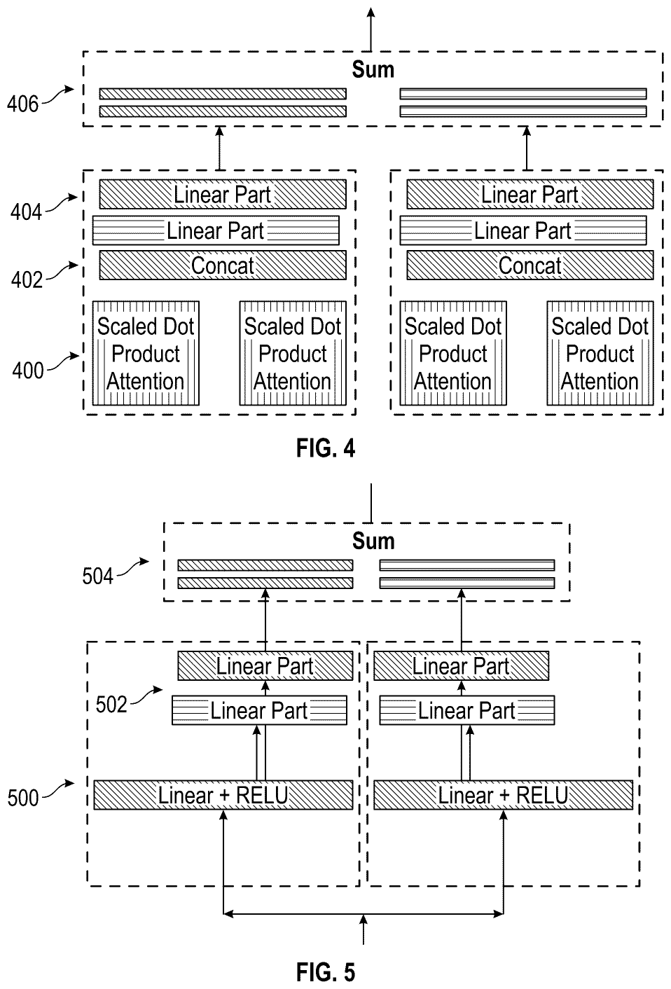

FIG. 4, illustrates a multi-headed attention mechanism split across multiple processing units, and illustrates how the attention mechanism is distributed to optimize computational efficiency and reduce latency. FIG. 4 is divided into two main sections, each representing a separate processing unit. Each section contains the components necessary for performing attention calculations for a subset of the attention heads.

At the core of each section, the Scaled Dot-Product Attention 400 is calculated. This involves computing attention scores by performing a dot product between the Query (Q) and Key (K) matrices, scaling the scores, applying an optional mask, and then passing the results through a Softmax function to obtain a probability distribution. These attention scores are then used to weight the Value (V) matrix.

The output from the Scaled Dot-Product Attention is then concatenated in step 402 with the outputs from other attention heads within the same section. This concatenation combines the information from multiple attention heads, allowing the model to attend to different parts of the input sequence simultaneously. Following the concatenation, the combined output is processed through a series of Linear layers 404. These layers transform the concatenated attention outputs into the final representation that will be used in subsequent layers of the neural network.

The final step in each section involves summing 406 the outputs from the linear layers of both processing units. This sum represents the aggregated information from all attention heads, across both processing units, and forms the final output of the multi-headed attention mechanism.

These processes assumes that the output of the scaled dot-product attention is broadcast across the different processing units, with each unit computing partial sums that are later unified. The use of unicast partial sums ensures that each processing unit contributes to the final result without redundant calculations, enhancing the overall efficiency of the attention mechanism.

In sum, FIG. 4 illustrates how the multi-headed attention mechanism can be effectively distributed across multiple processing units, highlighting the steps of scaled dot-product attention, concatenation, linear transformation, and summation. This approach leverages parallelism to handle large-scale machine learning models efficiently.

FIG. 5 illustrates the architecture of the final multi-layer perceptron (MLP) stage, which accounts for a significant proportion of the model's weights. FIG. 5 illustrates how the MLP stage is split across multiple processing units to optimize computational efficiency and manage the extensive weights involved. FIG. 5 is divided into two main sections, each representing a separate processing unit. Each section contains the components used for performing the linear and nonlinear transformations of the MLP.

At the bottom of the FIG. 5, arrows are shown entering Linear+ReLU layers 500. These arrows represent the input data feeding into these layers. This input data originate from earlier stages of a neural network. The input data is broadcast to all relevant chiplets, allowing for parallel processing within the Linear+ReLU layers 500.

In more detail, at the base of each section, the Linear+ReLU layers 500 perform an initial transformation. These layers apply a linear transformation followed by a Rectified Linear Unit (ReLU) activation function. The ReLU function introduces nonlinearity, which is crucial for the model to learn complex patterns.

Following the initial transformation, the output is split into Linear parts 502 for further processing. These Linear parts 502 are distributed across the processing units to balance the computational load and manage the extensive weights efficiently. The outputs from the Linear parts 502 are then summed 504 across the two processing units. This summation combines the results from each processing unit, ensuring that the final output incorporates contributions from all parts of the MLP. In the final step, the combined outputs are processed through additional Linear layers 506. These Linear layers 506 apply further transformations to produce the final output of the MLP stage, which will be used in subsequent layers of the neural network.

FIG. 5 illustrates how the final MLP stage can be effectively distributed across multiple processing units. This approach leverages parallelism to handle the large proportion of weights involved in the MLP, ensuring efficient computation and scalability for large-scale machine learning models. The combination of linear transformations, ReLU activations, and summation steps highlights the intricate process of managing and processing the extensive weights in the final MLP stage.

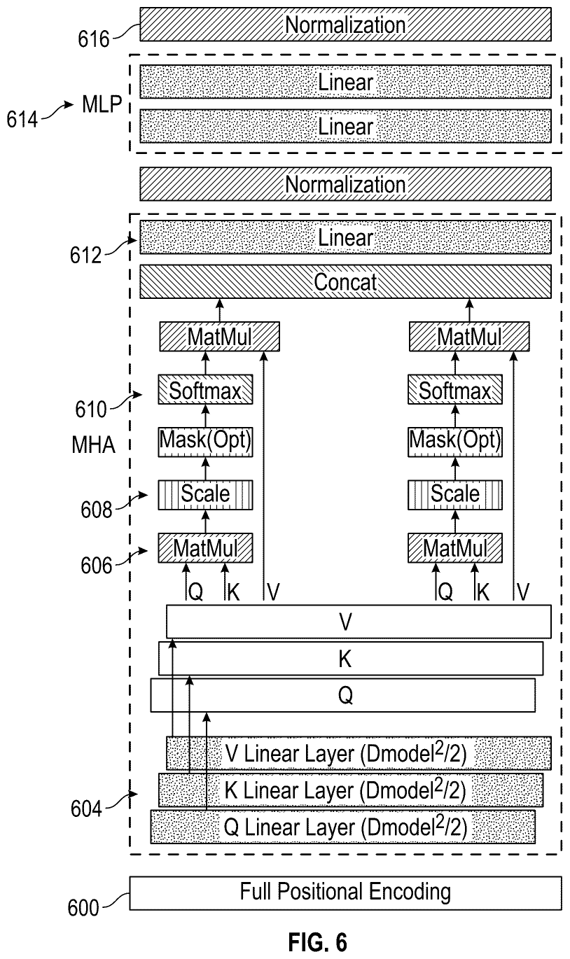

FIG. 6 provides an overview of the partitioning and execution on example processing units, such as chips or chiplets. In some instances, the entire vector needs to be present for normalization. This process is executed on the destination chiplet to ensure that all components of the vector are properly normalized. Normalization prepares the data for subsequent processing stages by standardizing the input values, thus enhancing the stability and performance of the neural network.

In one embodiment, the Multi-Layer Perceptron (MLP) block typically consists of two linear layers, which can be partitioned across chiplets. The inputs for the first linear layer are broadcast to all relevant chiplets, allowing parallel processing of the input data. After processing through the first linear layer, the outputs are reduced and consolidated for the second linear layer. This reduction step ensures that all partial results are combined efficiently. The entire vector needs to be present during these operations, and execution occurs on the destination chiplet to maintain consistency and accuracy in the computation.

The processing of the Multi-Headed Attention (MHA) partition generates partial sums that need to be reduced to a destination chiplet. The destination chiplet for reduction may vary per sample in the batch, allowing for flexible and dynamic allocation of resources based on the specific requirements of each sample. The entire MHA can be partitioned across multiple chiplets, with each partition executed locally on the corresponding chiplet. This local execution minimizes data transfer overhead and enhances computational efficiency.

Initially, in step 600, full positional encoding is applied to the input data to provide context to the positional relationships between tokens. This step encodes the position of each token in the input sequence, enabling the model to distinguish between different positions and understand the order of the tokens. Subsequently, in step 604, the data undergoes linear transformations through the Q (query), K (key), and V (value) linear layers. Each of these layers has dimensions of (Dmodel²/2), which means they transform the input data into a format suitable for the attention mechanisms. Specifically, the query, key, and value vectors are computed as follows: linear transformation to produce query vectors (Q), linear transformation to produce key vectors (K), and linear transformation to produce value vectors (V). These transformed vectors are then used in the attention mechanism.

In step 606, the transformed data undergoes matrix multiplication (MatMul) operations to compute the attention scores. This involves the multiplication of the query vectors with the transpose of the key vectors (MatMul(Q, K\hat{ }T)) to compute the raw attention scores. These attention scores are then scaled in step 608 by dividing by the square root of the dimensionality of the key vectors, which helps to stabilize the gradients during training. Optionally, the scores are masked to handle padded tokens or future tokens in the case of autoregressive models. This ensures that the model does not attend to irrelevant or unseen future information.

In step 610, the scaled and masked attention scores are passed through a softmax function to obtain the attention weights. The softmax function normalizes the scores so that they sum up to one, making them interpretable as probabilities. These attention weights are then used to compute weighted sums of the value vectors, resulting in contextually rich representations. The results from multiple attention heads are then concatenated in step 612. This concatenation step aggregates information from different attention heads, each focusing on different parts of the input sequence. The concatenated vectors are then passed through a final linear layer, integrating information from multiple attention heads and enhancing the model's ability to capture diverse aspects of the input data.

The entire process ensures that data is present only at one chiplet when starting and is broadcast to all relevant chiplets to facilitate parallel processing. Afterward, the data is normalized and processed using a multi-layer perceptron (MLP) in step 614, before a final normalization step 616 is performed. By partitioning and executing these operations across multiple chiplets, the system achieves high computational efficiency and scalability. Each chiplet handles a portion of the workload, reducing the overall processing time and enabling the system to manage large-scale neural network computations effectively.

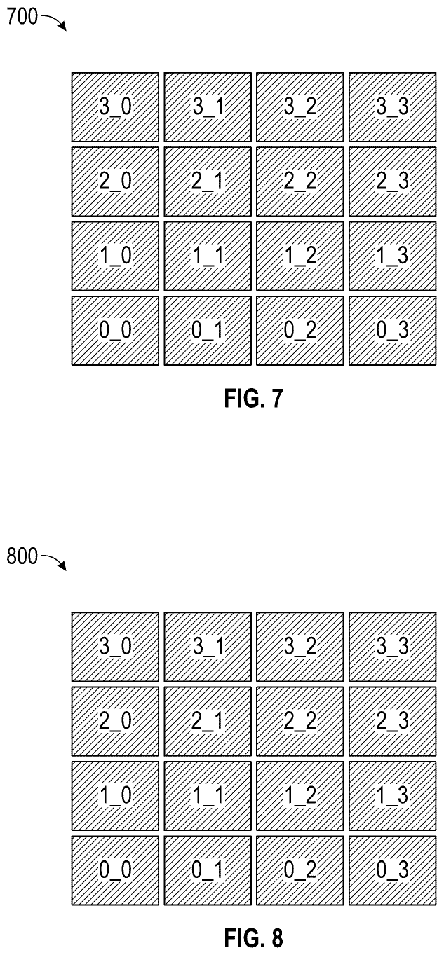

FIG. 7 illustrates the allocation 700 of samples to chiplets within a batch processing system. In one embodiment, each sample in a batch is allocated to a master chiplet. This master chiplet is responsible for being the source of broadcast and the destination for reduction for that particular sample. For instance, in a 4×4 configuration of chiplets, chiplet 0_0 is designated as the master for sample 0, chiplet 0_1 is the master for sample 1, and so on for 16 samples in the batch. This allocation ensures efficient data management and processing across the chiplet array.

FIG. 8 illustrates the broadcast and reduction process within a chiplet array, referencing the example configuration of 4×4 chiplets shown. In the configuration 800, each chiplet in the array, such as chiplet 3_0 or 2_1, broadcasts data to its row. For example, chiplet 3_0 broadcasts to chiplets 3_1, 3_2, and 3_3. Subsequently, the row broadcasts data to the column, meaning chiplet 3_0's data is further broadcast to chiplets 2_0, 1_0, and 0_0. This setup ensures that there are no conflicts within the broadcast for link resources, guaranteeing efficient data dissemination. As soon as data is available for broadcast, a chiplet can commence computing. This arrangement implies that the order of computation within a chiplet varies based on the availability of sample data, allowing for dynamic and efficient processing.

Reduction is implemented during the transfer of data. As data moves through the grid shown in configuration 800, it accumulates the current chiplet's partial sum along the way to its destination. For instance, as data moves from chiplet 3_0 through chiplets 2_0, 1_0, and 0_0, it aggregates partial sums from each chiplet. This ongoing accumulation during transfer enhances the efficiency of the reduction process, ensuring that final results are quickly and accurately consolidated at the destination chiplet. The example configuration of the 4×4 chiplet array demonstrates how this broadcast and reduction process is organized within the system.

Packets represent a multicycle command, encapsulating the computation of partial tensors. These packets contain all necessary layer metadata, memory pointers, and scheduling information. The method described can be efficiently represented as packets, allowing it to be compiled on various chips or chiplets.

Scheduling is performed without the need for runtime synchronization. Because the entire compute pipeline is deterministic, the schedule between multiple chips or chiplets can be synchronized during compile time and implemented during runtime. This approach ensures that schedules account for worst-case latency variations, maintaining efficient and reliable computation across the system.

Example analyses reveal computational requirements and memory configurations necessary for efficiently processing a Large Language Model (LLM). By examining different memory bandwidths and capacities, the performance metrics such as FLOPS and tokens per second are determined, providing insights into optimizing hardware resources for LLM computations.

Assuming the cost of running an LLM is one Multiply-Accumulate (MAC) operation for each parameter, which equates to 2 FLOPS, the computational requirements based on different memory configurations are determined. For a batch size of 1, the system requires 2 FLOPS per 2-byte weight. Therefore, the FLOPS needed per chip equals the memory bandwidth divided by the chip's HBM2 bandwidth of 256 Giga Bytes per second, resulting in 256 G FLOPS. The number of Tera Operations Per Second (TOPS) needed is calculated as the batch size divided by 4.

With an HBM2 memory of 8 GB, the entire memory delivers 8/256=32 milliseconds, translating to 32 tokens per batch per second. Using HBM2E memory, with a bandwidth of 460 Giga Bytes per second and capacities of 16 GB (stack of 8) or 8 GB (stack of four), the system handles up to 55 tokens per batch per second. HBM3 memory, despite having less than twice the bandwidth of HBM2E, offers only 16 GB, resulting in a lower tokens per batch per second rate compared to HBM2E.

The KV (Key-Value) cache is of significant importance. Without the KV cache, there are 3 times L times Dmodel squared MACs to be performed in the first Fully Connected (FC) layer, where L is the input length. With the KV cache, only three times Dmodel squared MACs are needed. This cache can be substantial, as it requires two times Dmodel times L bytes per batch for each layer, such as 2 GB per batch.

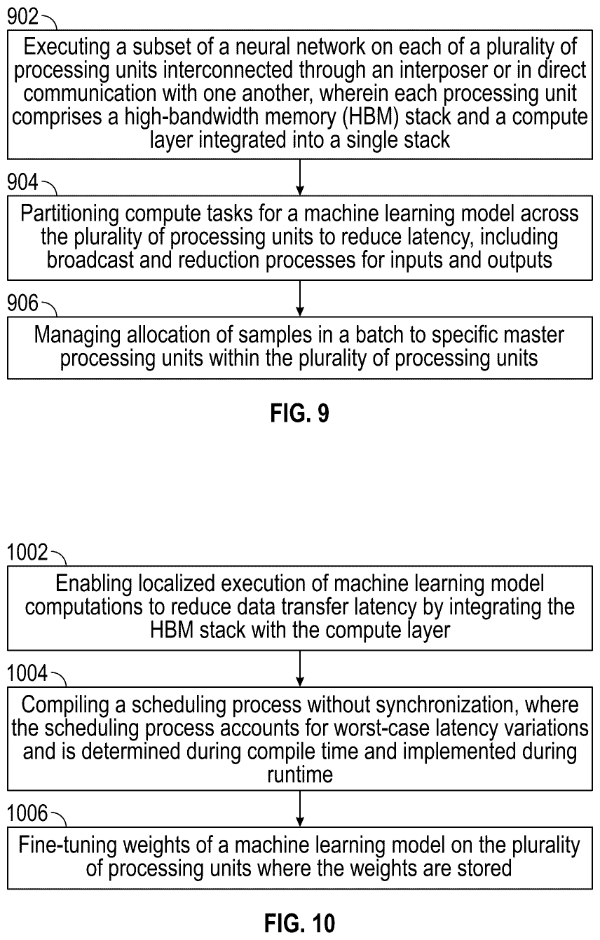

FIG. 9 illustrates a method for processing and deploying a machine learning model, detailing the steps of executing subsets of a neural network on interconnected processing units, partitioning compute tasks to reduce latency, managing sample allocation to master processing units, and synchronizing computations between fully connected layers within each processing unit.

In step 902, the method includes executing a subset of a neural network on each of a plurality of processing units interconnected through an interposer or in direct communication with one another, wherein each processing unit comprises a high-bandwidth memory (HBM) stack and a compute layer integrated into a single stack.

In step 904, the method includes partitioning compute tasks for a machine learning model across the plurality of processing units to reduce latency, including broadcast and reduction processes for inputs and outputs. In step 906, the method includes managing allocation of samples in a batch to specific master processing units within the plurality of processing units.

In step 908, the method includes synchronizing computation of the machine learning model between fully connected layers within each processing unit, wherein the processing units are interconnected by an interposer that enables high-speed communication and distributed processing.

FIG. 10 depicts the method steps for localized execution and scheduling, including enabling localized execution of machine learning model computations, compiling a scheduling process without synchronization, and fine-tuning weights on the processing units where the weights are stored.

In step 1002, the method includes enabling localized execution of machine learning model computations to reduce data transfer latency by integrating the HBM stack with the compute layer. In step 1004, the method includes compiling a scheduling process without synchronization, where the scheduling process accounts for worst-case latency variations and is determined during compile time and implemented during runtime. In step 1006, the method includes fine-tuning weights of a machine learning model on the plurality of processing units where the weights are stored.

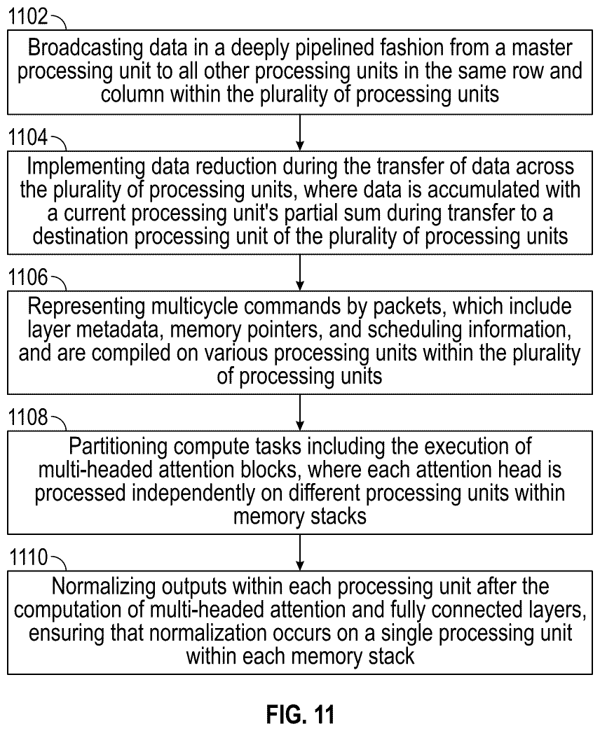

FIG. 11 illustrates the method steps for data handling and task partitioning, including broadcasting data in a deeply pipelined fashion, implementing data reduction during transfers, representing multicycle commands with packets, using a key-value cache, partitioning compute tasks for multi-headed attention blocks, and normalizing outputs within each processing unit.

In step 1102, the method includes broadcasting data in a deeply pipelined fashion from a master processing unit to all other processing units in the same row and column within the plurality of processing units. In step 1104, the method includes implementing data reduction during the transfer of data across the plurality of processing units, where data is accumulated with a current processing unit's partial sum during transfer to a destination processing unit of the plurality of processing units.

In step 1106, the method includes representing multicycle commands by packets, which include layer metadata, memory pointers, and scheduling information, and are compiled on various processing units within the plurality of processing units. In step 1108, the method includes using a key-value (KV) cache for storing and retrieving data, where availability of the KV cache reduces the required multiply-accumulate (MAC) operations in the first fully connected layer.

In step 1110, the method includes partitioning compute tasks, including the execution of multi-headed attention blocks, where each attention head is processed independently on different processing units within memory stacks. In step 1112, the method includes normalizing outputs within each processing unit after the computation of multi-headed attention and fully connected layers, ensuring that normalization occurs on a single processing unit within each memory stack.

The corresponding structures, materials, acts, and equivalents of all means or step-plus-function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for processing and deploying a machine learning model, the method comprising:
executing a subset of a neural network on each of a plurality of processing units interconnected through an interposer or in direct communication with one another, wherein each processing unit comprises a high-bandwidth memory (HBM) stack and a compute layer integrated into a single stack;
partitioning compute tasks for a machine learning model across the plurality of processing units to reduce latency, including broadcast and reduction processes for inputs and outputs; and
managing allocation of samples in a batch to specific master processing units within the plurality of processing units.

2. The method of claim 1, further comprising synchronizing computation of the machine learning model between fully connected layers within each processing unit.

3. The method of claim 1, further comprising compiling a scheduling process without synchronization, where the scheduling process accounts for worst-case latency variations and is determined during compile time and implemented during runtime.

4. The method of claim 1, further comprising fine-tuning weights of a machine learning model is performed on the plurality of processing units where the weights are stored.

5. The method of claim 1, further comprising broadcasting data in a deeply pipelined fashion from a master processing unit to all other processing units in a same row and column within plurality of processing units.

6. The method of claim 1, further comprising implementing data reduction during transfer of data across the plurality of processing units, where data is accumulated with a current processing unit's partial sum during transfer to a destination processing unit of the plurality of processing units.

7. The method of claim 1, wherein multicycle commands are represented by packets, which include layer metadata, memory pointers, and scheduling information, and are compiled on various processing units within the plurality of processing units.

8. The method of claim 1, further comprising using a key-value (KV) cache for storing and retrieving data, where availability of the KV cache reduces a required multiply-accumulate (MAC) operations in a first fully connected layer.

9. The method of claim 1, wherein the partitioning of compute tasks includes execution of multi-headed attention blocks, where each attention head is processed independently on different processing units within memory stacks.

10. The method of claim 1, further comprising normalizing outputs within each processing unit after the computation of multi-headed attention and fully connected layers, ensuring that normalization occurs on a single processing unit within each memory stack.

11. A system for processing and deploying machine learning models, comprising:
high-bandwidth memory (HBM) stacks, each of the stacks comprising dynamic random-access memory (DRAM) dies stacked vertically;
a logic die associated with each of the HBM stacks, wherein the logic die integrates a compute layer capable of executing a subset of a neural network, the compute layer including a Neural Processing Unit (NPU) designed to handle at least one neural network function; and
an interposer layer on which each of the HBM stacks and the logic dies are mounted, providing connectivity and routing between the logic dies and a package substrate, wherein the interposer includes high-speed communication channels to facilitate efficient data transfer between the NPUs and the HBM stacks, ensuring low-latency and high-throughput processing of the neural network subsets.

12. The system of claim 11, wherein the logic die is configured to:
assign each sample in a batch to a specific master HBM stack within the HBM stacks;
independently perform computation between two fully connected layers, wherein a first layer performs a broadcast of inputs and a second layer performs a reduction of outputs;
implement a scheduling process without runtime synchronization, wherein the scheduling process is determined during compile time and takes into account worst-case latency variations; and
fine-tune weights for machine learning models directly on the logic die.

13. The system of claim 12, wherein the interposer layer is configured to:
connect multiple HBM stacks and logic dies, forming a mesh grid to enable high-speed communication and distributed processing; and
support scalable and efficient processing by providing additional connectivity and routing between the logic dies and a package substrate.

14. The system of claim 11, wherein the logical die is configured to:
carry out deeply pipelined broadcasts of data from a master logic die to other logic dies in a same row and column; and
implement data reduction during transfer of data across the logic dies, wherein as data moves through a grid of interconnected logic dies, data is accumulated with a current logic die's partial sum during transfer to a destination logic die.

15. The system of claim 14, wherein the logical die is configured to represent multicycle commands, comprising layer metadata, memory pointers, and scheduling information, compiled on various computing elements within the HBM stacks.

16. The system of claim 14, wherein the logical die is configured to store and retrieve data from a key value (KV) cache, wherein availability of the KV cache reduces a computational load in a first fully connected (FC) layer by minimizing a number of multiply-accumulate (MAC) operations required, thereby reducing required memory and operations.

17. The system of claim 11, wherein the logical die is configured to handle allocation and deallocation of memory within the HBM stack, ensuring efficient use of memory resources during machine learning model processing.

18. A method for enhancing scalability and efficiency of machine learning model processing, comprising:
distributing subsets of a neural network across processing units that are interconnected;
executing machine learning model computations on each of the processing units to leverage local memory and processing resources;
dynamically partitioning and managing compute tasks to optimize latency, including broadcasting inputs and reducing outputs across the processing units;
assigning batches of samples to master processing units to centralize certain computational tasks while distributing others;
coordinating and synchronizing computation between fully connected layers within each processing unit to ensure efficient data processing;
implementing a deeply pipelined broadcast of data from the master processing units to other processing units in a same row and column;
performing data reduction during data transfers across the processing units, where data is aggregated with a current processing unit's partial sum during transfer to a destination; and
compiling multicycle commands into packets, which include layer metadata, memory pointers, and scheduling information, to facilitate execution across various processing units.

19. The method of claim 18, wherein each processing unit comprises a high-bandwidth memory (HBM) stack integrated with a compute layer, enabling localized execution of machine learning model computations to reduce data transfer latency.

20. The method of claim 19, further comprising fine-tuning weights of the machine learning model on the processing units where the weights are stored, enhancing the efficiency of model updates without requiring external data transfer.
